(19) United States
(12) Patent Application Publication
(10) Pub. No.: US 2026/0022988 A1
(43) Pub. Date: Jan. 22, 2026

(54) METHOD AND APPARATUS FOR DETERMINING DEFLECTION BASIN PARAMETERS, ROAD INSPECTION DEVICE, MEDIUM AND PRODUCT

(71) Applicant: WUHAN UNIVERSITY OF TECHNOLOGY, WUHAN (CN)

(72) Inventors: RONG LUO, WUHAN (CN); CHUANJIE HE, WUHAN (CN); FAN SANG, WUHAN (CN); YUN HOU, WUHAN (CN); YU CHEN, WUHAN (CN); TINGTING HUANG, WUHAN (CN); ZEYU ZHANG, WUHAN (CN); XUEMEI ZHANG, WUHAN (CN); CHUNHUI LI, WUHAN (CN)

(21) Appl. No.: 19/250,707

(22) Filed: Jun. 26, 2025

Related U.S. Application Data
(63) Continuation of application No. PCT/CN2024/127470, filed on Oct. 25, 2024.

(30) Foreign Application Priority Data
Jul. 19, 2024 (CN) 202410971516.4

(51) Int. Cl. G01M 5/00; G01S 13/88

(52) U.S. Cl. CPC G01M 5/005; G01S 13/885

(57) ABSTRACT

This invention provides a method and apparatus for determining deflection basin parameters, road inspection device, medium and product. The method comprises: obtaining real-time values of deflection basin evaluation indexes at any point in a test road section using ground-penetrating radar; inputting the real-time values of the deflection basin evaluation indexes into a deflection basin parameter prediction model to obtain predicted deflection basin parameter values; wherein, the deflection basin parameters prediction model is trained based on at least one deflection basin parameter value and deflection basin evaluation index values corresponding to reference points in a reference road section; the at least one deflection basin parameter value is determined by FWD, and the deflection basin evaluation index values are determined by the GPR. This invention enables the prediction of deflection basin parameters solely by acquiring real-time deflection basin evaluation indicator values through GPR, improving the efficiency of determining deflection basin parameters.

### FIELD OF THE DISCLOSURE

The invention relates to the fields of road engineering, particularly to a method and apparatus for determining deflection basin parameters, road inspection device, medium and product. The determined deflection basin parameters can measure the strength of the pavement structure. For example, by determining the shape and size of the deflection basin through the deflection basin parameters, the deformation of the pavement under load can be understood, and thus its load-bearing capacity can be evaluated.

### BACKGROUND

With the rapid development of highway construction, road systems have gradually entered a maintenance management phase. A rational evaluation of the structural bearing capacity of pavements is crucial. In assessing the structural bearing capacity of roads, deflection basin parameters serve as one of the key indicators for evaluating pavement structural strength.

In the prior art, deflection basin parameters are determined using a Falling Weight Deflectometer (FWD) to apply pulsed loads to the pavement, measure, and collect data on the resulting deflection basin under load. Hidden defects within the road structure, such as internal flaws or damage, significantly impact the structural strength of the pavement, which is reflected in the deflection measurements. Therefore, a correlation can be established between deflection basin parameters and pavement structural strength. By leveraging this correlation, the structural strength of the pavement can be determined from the deflection basin parameters obtained via FWD detection.

However, the process of determining deflection basin parameters using FWD involves applying loads to the pavement followed by data collection, which is complex and time-consuming. This results in low efficiency in obtaining deflection basin parameters. To address this limitation, there is a need to provide a method and apparatus for determining deflection basin parameters, road inspection device, medium and product to improve the efficiency of detection while maintaining accuracy.

### SUMMARY

In view of this, it is necessary to provide a method and apparatus for determining deflection basin parameters, road inspection device, medium and product to solve the technical problem of low efficiency in obtaining deflection basin parameters in the prior art.

In one aspect, to address the aforementioned technical challenges, the present invention provides a method for determining deflection basin parameters, comprises:
obtaining real-time values of deflection basin evaluation indexes at any point in a test road section using ground-penetrating radar;
inputting the real-time values of the deflection basin evaluation indexes into a deflection basin parameter prediction model to obtain predicted deflection basin parameter values;
wherein, the deflection basin parameters prediction model is trained based on at least one deflection basin parameter value and deflection basin evaluation index values corresponding to reference points in a reference road section; the at least one deflection basin parameter value is determined by falling weight deflectometer, and the deflection basin evaluation index values are determined by the ground-penetrating radar.

In some possible embodiment, before obtaining real-time values of deflection basin evaluation indexes at any point in a test road section using ground-penetrating radar, comprises: establishing the deflection basin evaluation indexes;
wherein, the deflection basin evaluation indexes include a crack cross-sectional area index, a settlement rate, a looseness rate, and a void rate.

In some possible embodiment, before inputting the real-time values of the deflection basin evaluation indexes into a deflection basin parameter prediction model to obtain predicted deflection basin parameter values, comprises:
acquiring the at least one deflection basin parameter value and the deflection basin evaluation index values of the reference point, and training the deflection basin parameter prediction model based on the at least one deflection basin parameter value and the deflection basin evaluation index values.

In some possible embodiment, acquiring the deflection basin evaluation index values of the reference point, comprises:
obtaining a reflected voltage and a radar image of the reference point using the ground-penetrating radar;
determining the crack cross-sectional area index value based on the reflected voltage;
determining the settlement rate value, the looseness rate value, and the void rate value based on the radar image.

In some possible embodiment, determining the crack cross-sectional area index value based on the reflected voltage, comprises:
determining a number of voltage peaks and peak voltage values of the reflected voltage, and determining a number of hidden cracks at the reference point based on the number of voltage peaks;
determining hidden crack depth and hidden crack width of each hidden crack based on the peak voltage values, a first correspondence between peak voltage and hidden crack depth, and a second correspondence between peak voltage and hidden crack width;
determining the crack cross-sectional area index value based on the hidden crack depth and the hidden crack width.

In some possible embodiment, determining the settlement rate value, the looseness rate value, and the void rate value based on the radar image, comprises:
identifying at least one settlement region, at least one looseness region, and at least one void region in the radar image;
determining a settlement location and settlement area for each settlement region, and determining the settlement rate value based on the settlement location and settlement area;
determining a looseness location and looseness area for each looseness region, and determining the looseness rate value based on the looseness location and looseness area;
determining a void location and void area for each void region, and determining the void rate value based on the void location and void area.

In some possible embodiment, determining the settlement rate value based on the settlement location and settlement area, comprises:
determining a settlement location weight for each settlement region based on the settlement location;
determining the settlement rate value based on the settlement location weight and the settlement area.

In some possible embodiment, determining a settlement location weight for each settlement region based on the settlement location, comprises:
establishing a first mapping relationship between a settlement center and the settlement location weight;
determining a settlement center of the settlement location, and determining the settlement location weight based on the settlement center and the first mapping relationship.

In some possible embodiment, the deflection basin evaluation indexes further include a rut death, an international roughness index, and a damage rate,
wherein, the method for determining deflection basin parameters further comprises:
determining a rut depth value, an international roughness index value, and a damage rate value of the reference point using a multifunctional road condition rapid detection system.

In some possible embodiment, the at least one deflection basin parameter value includes a first deflection basin parameter value at a first sampling point, the deflection basin parameter prediction model includes a first deflection basin parameter prediction sub-model; wherein, before inputting the real-time values of the deflection basin evaluation indexes into the deflection basin parameter prediction model to obtain the predicted deflection basin parameter values, the method further comprises:
training a first initial deflection basin parameter prediction sub-model using the first deflection basin parameter value, the crack cross-sectional area index value, the settlement rate value, the looseness rate value, the void rate value, the rut depth value, the international roughness index value, and the damage rate value to obtain the first deflection basin parameter prediction sub-model.

In some possible embodiment, the at least one deflection basin parameter value includes a first deflection basin parameter value at a first sampling point and a second deflection basin parameter value at a second sampling point, wherein a distance between the second sampling point and the reference point is greater than a distance between the first sampling point and the reference point, the deflection basin parameter prediction model includes a first deflection basin parameter prediction sub-model and a second deflection basin parameter prediction sub-model; wherein, before inputting the real-time values of the deflection basin evaluation indexes into the deflection basin parameter prediction model to obtain the predicted deflection basin parameter values, the method further comprises:
training a first initial deflection basin parameter prediction sub-model using the first deflection basin parameter value, the crack cross-sectional area index value, the settlement rate value, the looseness rate value, the void rate value, the rut depth value, the international roughness index value, and the damage rate value to obtain the first deflection basin parameter prediction sub-model;
training a second initial deflection basin parameter prediction sub-model using the second deflection basin parameter value, the crack cross-sectional area index value, the looseness rate value, the international roughness index value, and the rut depth value to obtain the second deflection basin parameter prediction sub-model.

In some possible embodiment, training a second initial deflection basin parameter prediction sub-model using the second deflection basin parameter value, the crack cross-sectional area index value, the looseness rate value, the international roughness index value, and the rut depth value to obtain the second deflection basin parameter prediction sub-model, comprises:
determining a pavement structural incompleteness rate value based on the crack cross-sectional area index value and the looseness rate value;
determining a pavement overall roughness index value based on the international roughness index value and the rut depth value;
training the second initial deflection basin parameter prediction sub-model using the second deflection basin parameter value, the pavement structural incompleteness rate value and the pavement overall roughness index value to obtain the second deflection basin parameter prediction sub-model.

In some possible embodiment, the at least one deflection basin parameter value includes a first deflection basin parameter value at a first sampling point, a second deflection basin parameter value at a second sampling point, and a third deflection basin parameter value at a third sampling point, wherein a distance between the second sampling point and the reference point is greater than a distance between the first sampling point and the reference point, and a distance between the third sampling point and the reference point is greater than the distance between the second sampling point and the reference point; the deflection basin parameter prediction model includes a third deflection basin parameter prediction sub-model;
before inputting the real-time values of the deflection basin evaluation indexes into the deflection basin parameter prediction model to obtain the predicted deflection basin parameter values, the method further comprises:
training a first initial deflection basin parameter prediction sub-model using the first deflection basin parameter value, the crack cross-sectional area index value, the settlement rate value, the looseness rate value, the void rate value, the rut depth value, the international roughness index value, and the damage rate value to obtain the first deflection basin parameter prediction sub-model;
training a second initial deflection basin parameter prediction sub-model using the second deflection basin parameter value, the crack cross-sectional area index value, the looseness rate value, the international roughness index value, and the rut depth value to obtain the second deflection basin parameter prediction sub-model;
training a third initial deflection basin parameter prediction sub-model using the third deflection basin parameter value, the crack cross-sectional area index value, the settlement rate value, the looseness rate value, and the void rate value to obtain the third deflection basin parameter prediction sub-model.

In some possible embodiment, the real-time values of deflection basin evaluation indexes include a real-time crack cross-sectional area index value, a real-time settlement rate value, a real-time looseness rate value, a real-time void rate value, a real-time rut depth value, a real-time international roughness index value, and a real-time damage rate value; wherein inputting the real-time values of the deflection basin evaluation indexes into the deflection basin parameter prediction model to obtain the predicted deflection basin parameter values comprises:
inputting the real-time crack cross-sectional area index value, the real-time settlement rate value, the real-time looseness rate value, the real-time void rate value, the real-time rut depth value, the real-time international roughness index value, and the real-time damage rate value into the first deflection basin parameter prediction sub-model to obtain a first predicted deflection basin parameter value;
inputting the real-time crack cross-sectional area index value, the real-time looseness rate value, the real-time international roughness index value, and the real-time rut depth value into the second deflection basin parameter prediction sub-model to obtain a predicted base layer response index value, and determining a second predicted deflection basin parameter value based on the predicted base layer response index value and the first predicted deflection basin parameter value;
inputting the real-time crack cross-sectional area index value, the real-time settlement rate value, the real-time looseness rate value, and the real-time void rate value into the third deflection basin parameter prediction sub-model to obtain a predicted intermediate layer index value, and determining a third predicted deflection basin parameter value based on the predicted intermediate layer index value and the second predicted deflection basin parameter value.

In some possible embodiment, the at least one deflection basin parameter value further includes a fourth deflection basin parameter value at a fourth sampling point, wherein a distance between the fourth sampling point and the reference point is greater than the distance between the third sampling point and the reference point; the deflection basin parameter prediction model further includes a fourth deflection basin parameter prediction sub-model;
before inputting the real-time values of the deflection basin evaluation indexes into the deflection basin parameter prediction model to obtain the predicted deflection basin parameter values, the method further comprises:
training a fourth initial deflection basin parameter prediction sub-model using the first predicted deflection basin parameter value, the second predicted deflection basin parameter value, and the third predicted deflection basin parameter value to obtain the fourth deflection basin parameter prediction sub-model.

In some possible embodiment, the at least one deflection basin parameter value further includes a fifth deflection basin parameter value at a fifth sampling point, wherein a distance between the fifth sampling point and the reference point is greater than the distance between the fourth sampling point and the reference point;
before inputting the real-time values of the deflection basin evaluation indexes into the deflection basin parameter prediction model to obtain the predicted deflection basin parameter values, the method further comprises:
obtaining a fourth predicted deflection basin parameter value using the fourth deflection basin parameter prediction sub-model;
training a fifth initial deflection basin parameter prediction sub-model using the first predicted deflection basin parameter value, the second predicted deflection basin parameter value, the third predicted deflection basin parameter value, and the fourth predicted deflection basin parameter value to obtain a fifth deflection basin parameter prediction sub-model.

In another aspect, the present invention also provides an apparatus for determining deflection basin parameters, comprises:
evaluation index real-time values acquisition unit, configured to obtain real-time values of deflection basin evaluation indexes at any point in a test road section using ground-penetrating radar;
deflection basin parameter prediction unit, configured to input the real-time values of the deflection basin evaluation indexes into a deflection basin parameter prediction model to obtain predicted deflection basin parameter values;
wherein, the deflection basin parameter prediction model is trained based on at least one deflection basin parameter value and deflection basin evaluation index values corresponding to reference points in a reference road section; the at least one deflection basin parameter value is determined by falling weight deflectometer, and the deflection basin evaluation index values are determined by the ground-penetrating radar.

In another aspect, the present invention also provides a road inspection device, comprising memory and processor, among which,
the memory is used to store a program;
the processor coupled with the memory, is used to execute the program stored in the memory to implement the steps in the method for determining deflection basin parameters according to any of the aforementioned possible embodiment methods.

In another aspect, the present invention also provides a computer-readable storage medium, the computer-readable storage medium stores a program or instructions that, when executed by a processor, implement the steps of the method for determining deflection basin parameters according to the any of the aforementioned possible embodiment methods.

In another aspect, the present invention also provides a computer program product, comprising a computer program/instructions, the computer program/instructions, when executed by a processor, implement the steps of the method for determining deflection basin parameters according to any of the aforementioned possible embodiment methods.

The beneficial effects of adopting the aforementioned embodiments are as follows: The method for determining deflection basin parameters provided by the present invention only needs to obtain the real-time values of the deflection basin evaluation indexes at any point in the test road section based on the ground-penetrating radar, and then input these values into the deflection basin parameter prediction model to obtain the predicted value of the deflection basin parameters. Compared with the falling weight deflectometer, the detection process of the ground-penetrating radar is simple, which improves the efficiency of determining deflection basin parameters.

Further, when the falling weight deflectometer is used to detect deflection basin parameters, the road needs to be closed, while the ground-penetrating radar does not. Therefore, the present invention can quickly determine the deflection basin parameters without affecting road traffic.

### BRIEF DESCRIPTION OF THE FIGURES

To describe the technical solutions in embodiments of the present invention more clearly, the following briefly introduces the accompanying drawings for describing the embodiments. Apparently, the accompanying drawings in the following description show merely some embodiments of the present invention, and those skilled in the art may still derive other accompanying drawings from these accompanying drawings without making creative efforts.

FIG. 1 is a flowchart of the method for determining deflection basin parameters provided by the present invention.

FIG. 2 is a flowchart of acquiring the deflection basin evaluation index values of the reference point provided by the present invention.

FIG. 3 is a flowchart of S202 in FIG. 2 provided by the present invention.

FIG. 4 is a flowchart of S203 in FIG. 2 provided by the present invention.

FIG. 5 is a flowchart of determining the settlement rate value provided by the present invention.

FIG. 6 is a flowchart of obtaining the second deflection basin parameter prediction sub-model provided by the present invention.

FIG. 7 is a flowchart of S102 in FIG. 1 provided by the present invention.

FIG. 8 is a schematic diagram of sequential prediction provided by the present invention.

FIG. 9 is a schematic diagram of verifying the prediction accuracy of the deflection basin parameter prediction model provided by the present invention.

FIG. 10 is a schematic structural diagram of an apparatus for determining deflection basin parameters provided by the present invention.

FIG. 11 is a schematic structural diagram of the road inspection device provided by the present invention.

### DETAILED DESCRIPTION

The following clearly and completely describes the technical solutions in the embodiments of the present invention with reference to the accompanying drawings in the embodiments of the present invention. Apparently, the embodiments described are merely a part rather than all of the embodiments of the present invention. Based on the embodiments in the present invention, all other embodiments obtained by those skilled in the art without making creative efforts shall fall within the scope of protection of the present invention.

It should be understood that the schematic drawings are not drawn in proportion to physical objects. Flowcharts used in the present invention show operations implemented according to some embodiment of the present invention. It should be understood that the operations of the flowcharts can be implemented out of order, and the steps without a logical contextual relationship may be implemented in reverse order or implemented at the same time. In addition, under the guidance of the content of the present invention, those skilled in the art can add one or more other operations to each flowchart, and can also remove one or more operations from each flowchart. Some of block diagrams shown in the accompanying drawings are functional entities and do not necessarily have to correspond to physically or logically separate entities. These functional entities may be implemented in software, or implemented in one or more hardware modules or integrated circuits, or implemented in different network and/or processor systems and/or micro-controller systems.

The reference to “Embodiment” herein means that a particular feature, structure, or characteristic described with reference to the embodiment may be included in at least one embodiment of the present invention. The appearances of the phrases in various places in the specification may not refer to the same embodiment, or to an independent or alternative embodiment that is mutually exclusive of other embodiments. Those skilled in the art explicitly and implicitly understand that the embodiment described herein may be combined with other embodiments.

Before presenting the embodiments, the working principles of the FWD (Falling Weight Deflectometer) and the ground-penetrating radar, and the deflection basin will be introduced first.

The working principle of the FWD is as follows: under the control of a computer, a heavy hammer with a certain mass is lifted to a certain height by a hydraulic transmission device and then dropped freely. The impact force acts on the bearing plate and is transmitted to the road surface, thus applying a pulse load to the road surface. This causes instantaneous deformation on the road surface. Sensors located at different distances from the measurement point detect the deformation of the surface of the structural layer, and the recording system transmits the signals to the computer. In this way, the dynamic deflection and the deflection basin generated under the action of the dynamic load are measured.

As a representative of non-destructive road detection technologies, ground penetrating radar (GPR) analyzes subsurface conditions through the propagation characteristics of electromagnetic waves: when electromagnetic waves propagate, they are affected by the dielectric properties of different media. Changes in the dielectric properties of the propagation medium cause the electromagnetic waves to reflect. Therefore, both the interfaces between medium layers and specific objects that differ from their surrounding media will cause electromagnetic wave reflections. By collecting and analyzing these reflected signals, the detection of subsurface layers or targets can be achieved.

Deflection basin refers to the local subsidence, that is, vertical deformation, of the road surface under the action of a load. The shape reflected on the road surface is basin-shaped with the load-applied point as the center, which is called deflection basin.

In the prior art, in order to obtain the deflection basin parameters at an unknown location, it is necessary to use a falling weight deflectometer to apply loads, collect data, and analyze the data at this unknown location. The process is complex. With the rapid development of highway construction, a large amount of historical deflection basin parameters already exist. If these historical parameters are used to predict the deflection basin parameters at unknown locations, the efficiency of determining deflection basin parameters will be greatly improved. To achieve this goal, the embodiments of the present invention provide a method and apparatus for determining deflection basin parameters, road inspection device, medium and product.

It should be understood that: The method for determining deflection basin parameters provided by the present invention can be implemented in any device based on the method for determining deflection basin parameters. For example, in a pavement detection device integrated with a ground-penetrating radar. The pavement detection device includes a ground-penetrating radar and a host computer. The ground-penetrating radar is used to collect the real-time values of the deflection basin evaluation indexes at any point in the test road section. The host computer has a built-in deflection basin parameter prediction model, and the deflection basin parameters are determined based on the real-time values of the deflection basin evaluation indexes and the deflection basin parameter prediction model. Moreover, the host computer includes a display interface, which displays the determined deflection basin parameters and the deflection basin curve constructed from the deflection basin parameters.

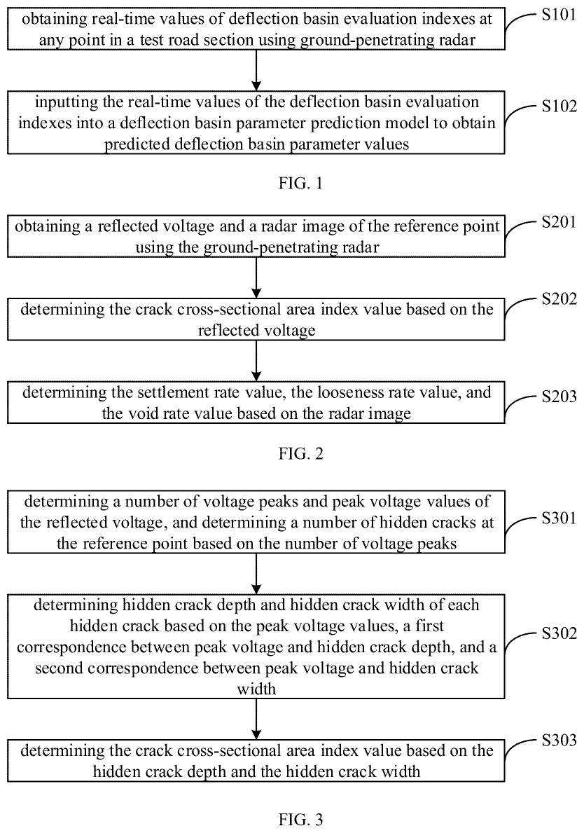

FIG. 1 is a flowchart of the method for determining deflection basin parameters, as shown in FIG. 1, the method for determining deflection basin parameters, comprises:
S101, obtaining real-time values of deflection basin evaluation indexes at any point in a test road section using ground-penetrating radar;
S102, inputting the real-time values of the deflection basin evaluation indexes into a deflection basin parameter prediction model to obtain predicted deflection basin parameter values;
wherein, the deflection basin parameters prediction model is trained based on at least one deflection basin parameter value and deflection basin evaluation index values corresponding to reference points in a reference road section; the at least one deflection basin parameter value is determined by falling weight deflectometer, and the deflection basin evaluation index values are determined by the ground-penetrating radar.

Specifically, S101 is as follows: electromagnetic waves are emitted into the test road section through the ground-penetrating radar, and the real-time values of the deflection basin evaluation indexes at any point are obtained based on the reflected electromagnetic waves.

It should be understood that before performing S102, it is necessary to train the deflection basin parameter prediction model to ensure that the model's prediction performance meets the requirements.

Specifically, the model training process is as follows: construct an initial deflection basin parameter prediction model, input the deflection basin evaluation index values into the initial deflection basin parameter prediction model to obtain predicted value, compare the predicted value with the deflection basin parameter value, and modify the model parameters of the initial deflection basin parameter prediction model according to the comparison results. This process is repeated until the difference between the predicted value and the deflection basin parameter value is less than a preset difference, at which point the deflection basin parameter prediction model is obtained.

It should be noted that the reference point is any point in the test road section.

It is understandable that the deflection basin parameter prediction model is a deep-learning model, such as any one of a Convolutional Neural Network (CNN) model, a Deep Convolutional Inverse Graphics Network (DCIGN) model, a Generative Adversarial Network (GAN) model, a Deep Residual Network (DRN) model, etc.

Compared with the prior art, the method for determining deflection basin parameters provided by the present invention only needs to obtain the real-time values of the deflection basin evaluation indexes at any point in the test road section based on the ground-penetrating radar, and then input these values into the deflection basin parameter prediction model to obtain the predicted value of the deflection basin parameters. In other words, the existing historical deflection basin parameters are utilized to predict the deflection basin parameters of any unknown point. There is no need to determine the deflection basin parameters through the FWD every time. Instead, only the real-time values of the deflection basin evaluation indices obtained by the ground-penetrating radar are required to predict the deflection basin parameters, which improves the efficiency of determining the deflection basin parameters.

Further, when the falling weight deflectometer is used to detect deflection basin parameters, the road needs to be closed, while the ground-penetrating radar does not. Therefore, the present invention can quickly determine the deflection basin parameters without affecting road traffic.

It is understandable that the more comprehensive the deflection basin evaluation indexes are, the higher the prediction accuracy of the deflection basin parameter prediction model will be. Therefore, in some embodiments of the present invention, before S101, the method further comprises:
establishing the deflection basin evaluation indexes;
wherein, the deflection basin evaluation indexes include a crack cross-sectional area index, a settlement rate, a looseness rate, and a void rate.

It is understandable that the crack cross-sectional area index represents the severity of cracks and is an index used to characterize the size of cracks. The settlement rate refers to the degree of settlement, where settlement refers to the uneven vertical deformation and local sinking of the road surface. The looseness rate represents the degree of looseness, which refers to the phenomenon where the binder is lost or detached, and the particles lose their adhesion and become loose. The void rate represents the degree of voids, where voids refer to the tiny gaps that appear between the road surface base plate and the subbase.

Since it is necessary to train and obtain the deflection basin parameter prediction model before S102, and the training of the deflection basin parameter prediction model depends on the deflection basin parameter value and the deflection basin evaluation index values, therefore, before S102, it also includes acquiring the deflection basin evaluation index values of the reference point. Specifically, as shown in FIG. 2, acquiring the deflection basin evaluation index values of the reference point, comprises:
S201, obtaining a reflected voltage and a radar image of the reference point using the ground-penetrating radar;
S202, determining the crack cross-sectional area index value based on the reflected voltage;
S203, determining the settlement rate value, the looseness rate value, and the void rate value based on the radar image.

Specifically, S201 involves: transmitting electromagnetic waves via the GPR to the reference point, and receiving the reflected signals from the GPR, which include reflected voltage values and radar image.

It should be noted that the GPR can quickly obtain the reflected voltage values and radar image of the reference point simply by emitting electromagnetic waves. This approach significantly improves the efficiency of acquiring deflection basin evaluation index values, thereby enhancing the overall efficiency of determining deflection basin parameters.

In some possible embodiment, as shown in FIG. 3, S202 comprises:
S301, determining a number of voltage peaks and peak voltage values of the reflected voltage, and determining a number of hidden cracks at the reference point based on the number of voltage peaks;
S302, determining hidden crack depth and hidden crack width of each hidden crack based on the peak voltage values, a first correspondence between peak voltage and hidden crack depth, and a second correspondence between peak voltage and hidden crack width;
S303, determining the crack cross-sectional area index value based on the hidden crack depth and the hidden crack width.

Wherein, the first correspondence between peak voltage and hidden crack depth is:

$$y = 0.0241 {d}^{2} + 4.9745 d + 283.14$$

Wherein, the second correspondence between peak voltage and hidden crack width is:

$$y = - 0.0089 {w}^{2} + 2.3311 w + 262.68$$

Wherein, y is peak voltage value, d is hidden crack depth, w is hidden crack width.

Specifically, the crack cross-sectional area index value is:

$$CSA = \frac{{\sum }_{i = 1}^{n} {A}_{i} {D}_{i}}{L}$$

Wherein, CSA is the crack cross-sectional area index value, Aᵢ is the i-th hidden crack width, Dᵢ is the i-th hidden crack depth, n is the number of hidden cracks, L is evaluation length.

Wherein, the evaluation length is the total length of the test road section.

In some specific embodiments, when there are cracks in the road section, the transmitted voltage fluctuates to form peaks. Therefore, there is a one-to-one correspondence between the peak values of the reflected voltage and the number of hidden cracks. Thus, the number of hidden cracks can be determined by the peak values of the reflected voltage.

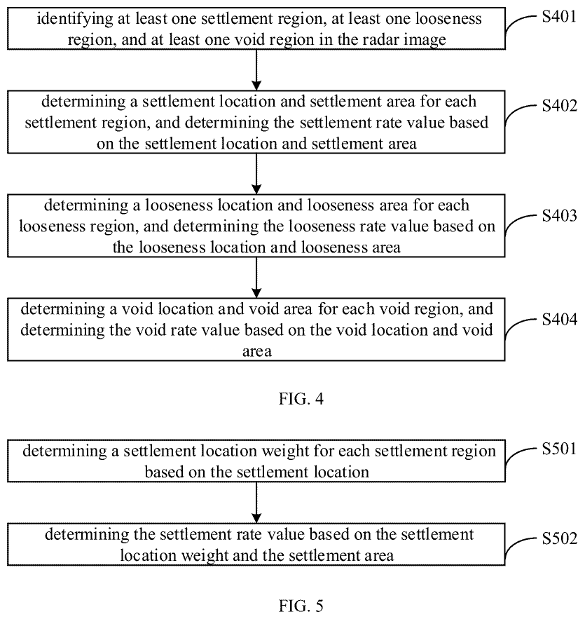

In some specific embodiments, as shown in FIG. 4, S203 comprises:
S401, identifying at least one settlement region, at least one looseness region, and at least one void region in the radar image;
S402, determining a settlement location and settlement area for each settlement region, and determining the settlement rate value based on the settlement location and settlement area;
S403, determining a looseness location and looseness area for each looseness region, and determining the looseness rate value based on the looseness location and looseness area;
S404, determining a void location and void area for each void region, and determining the void rate value based on the void location and void area.

Specifically, S401 involves: performing feature extraction and recognition on the radar image using an image recognition model to identify settlement areas, loose areas, and void areas.

It should be understood that the image recognition model can be any one of a CNN model, VGG model, GoogLeNet model, SENet model, etc.

The location and area of settlement, the location and area of looseness, and the location and area of voids can also be directly identified and obtained by the image recognition model.

In a specific embodiment of the present invention, as shown in FIG. 5, determining the settlement rate value based on the settlement location and settlement area in S402, comprises:
S501, determining a settlement location weight for each settlement region based on the settlement location;
S502, determining the settlement rate value based on the settlement location weight and the settlement area.

In some embodiments of the present invention, by determining the settlement location weight of the settlement area based on the settlement location, the accuracy of the determined settlement rate value can be improved, thereby enhancing the prediction accuracy of the deflection basin parameters.

In a specific embodiment of the present invention, S501 specifically includes: establishing a first mapping relationship between a settlement center and the settlement location weight; determining a settlement center of the settlement location, and determining the settlement location weight based on the settlement center and the first mapping relationship.

Specifically, the settlement rate value is:

$$ISR = \frac{{\sum }_{i = 1}^{m} {w}_{1 i} {A}_{1 i}}{A}$$

$${w}_{1 i} = 1.167 - 0.017 {x}_{1 i}$$

Wherein, ISR is the settlement rate value, A₁ᵢ is the i-th settlement area, w₁ᵢ Dᵢ is the i-th settlement location weight, A is evaluation area, x₁ᵢ is the distance from the settlement center of the i-th settlement area to the road surface, m is the total number of settlement areas.

It should be understood that the calculation processes and principles of the looseness rate value, the void rate, and the settlement rate value are all the same.

Specifically, the looseness rate value is:

$$PLR = \frac{{\sum }_{i = 1}^{p} {w}_{2 i} {A}_{2 i}}{A}$$

$${w}_{2 i} = 1.057 - 0.014 {x}_{2 i}$$

Wherein, PLR is the looseness rate value, A₂ᵢ is the i-th looseness area, w₂ᵢ is the i-th looseness location weight, x₂ᵢ is the distance from the looseness center of the i-th looseness area to the road surface, p is the total number of looseness areas.

Specifically, the void rate value is:

$$VR = \frac{{\sum }_{i = 1}^{q} {w}_{3 i} {A}_{3 i}}{A}$$

$${w}_{3 i} = 1.128 - 0.014 {x}_{3 i}$$

Wherein, VR is the void rate value, A₃ᵢ is the i-th void area, w₃ᵢ is the i-th void location weight, x₃ᵢ is the distance from the void center of the i-th void area to the road surface, q is the total number of void areas.

It should be noted that settlement mainly occurs in the base layer and the middle and lower layers of the road, looseness occurs in the base layer and the surface layer, and voids generally appear in the base layer and the subbase layer. In the embodiments of the present invention, when the center of the disease occurrence is located at the uppermost part of the pavement structure, the highest weight of 1 is taken. When the center of the disease occurrence is located at the lowermost part of the pavement structure, the lowest weight of 0.4 is taken.

In order to further improve the comprehensiveness of the deflection basin evaluation indexes and enhance the prediction accuracy of the deflection basin parameters, in some embodiments of the present invention, the deflection basin evaluation indexes also include a rut death, an international roughness index, and a damage rate;
wherein, the method for determining deflection basin parameters further comprises:
determining a rut depth value, an international roughness index value, and a damage rate value of the reference point using a multifunctional road condition rapid detection system (CICS).

In the embodiments of the present invention, in addition to the deflection basin evaluation indexes obtained by the ground-penetrating radar, three additional deflection basin evaluation indexes, namely rut death, international roughness index, and damage rate, are obtained through CICS. This further improves the comprehensiveness of the deflection basin evaluation indices, and thus can further enhance the prediction accuracy of the deflection basin parameters.

In the embodiments, the at least one deflection basin parameter value includes a first deflection basin parameter value at a first sampling point, the deflection basin parameter prediction model includes a first deflection basin parameter prediction sub-model; wherein, before S102, the method further comprises:
training a first initial deflection basin parameter prediction sub-model using the first deflection basin parameter value, the crack cross-sectional area index value, the settlement rate value, the looseness rate value, the void rate value, the rut depth value, the international roughness index value, and the damage rate value to obtain the first deflection basin parameter prediction sub-model.

It should be noted that the distance between the first sampling point and the reference point is less than the preset distance. Preferably, the first sampling point coincides with the reference point.

Since what is reflected at the first sampling point is the overall structural strength of the road surface of the road section, in order to ensure the accuracy of the first deflection basin parameter prediction sub-model, in the embodiments, all the deflection basin evaluation indexes mentioned in the previous embodiments are used as the input of the first deflection basin parameter prediction sub-model, and the first deflection basin parameter prediction sub-model is trained, which can improve the prediction accuracy and precision of the first deflection basin parameter prediction sub-model after the training is completed.

Since after the falling weight deflectometer applies an impulse load to the reference point, the deformation of the road surface does not only occur at the reference point, but the road surface within a certain range including the reference point will be deformed to form a deflection basin. Generally speaking, the shape of the deflection basin is saddle-shaped. Therefore, in order to improve the accuracy of the description of the deflection basin, that is, to improve the accuracy of the prediction of the deflection basin parameters, in some embodiments of the present invention, in addition to constructing the first sampling point and the first deflection basin parameter value, at least one deflection basin parameter value also includes the second deflection basin parameter value of the second sampling point. The distance between the second sampling point and the reference point is greater than the distance between the first sampling point and the reference point, and the deflection basin parameter prediction model includes the second deflection basin parameter prediction sub-model.
then, before S102, the method further comprises:
training a second initial deflection basin parameter prediction sub-model using the second deflection basin parameter value, the crack cross-sectional area index value, the looseness rate value, the international roughness index value, and the rut depth value to obtain the second deflection basin parameter prediction sub-model.

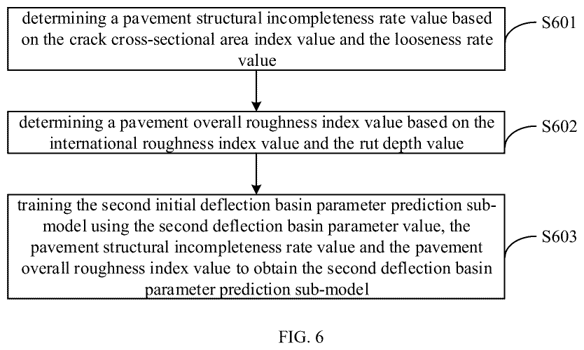

Among them, the second initial deflection basin parameter prediction sub-model focuses on the structural performance of the pavement surface layer of the road section. Since the undulation of the pavement functional layer is a reflection of the damage to the surface layer structure, it generally falls into two types of undulation. One is the pavement roughness caused by uneven settlement, and the other is the pavement rutting caused by the poor high-temperature performance of the material. These two types of diseases will lead to a decline in the structural performance of the surface layer. That is to say, the structural performance of the pavement is reflected to a certain extent in the pavement roughness and rut. In order to improve the accuracy of the second deflection basin parameter prediction sub-model, in some embodiments of the present invention, as shown in FIG. 6, training a second initial deflection basin parameter prediction sub-model using the second deflection basin parameter value, the crack cross-sectional area index value, the looseness rate value, the international roughness index value, and the rut depth value to obtain the second deflection basin parameter prediction sub-model, comprises:
S601, determining a pavement structural incompleteness rate value based on the crack cross-sectional area index value and the looseness rate value;
S602, determining a pavement overall roughness index value based on the international roughness index value and the rut depth value;
S603, training the second initial deflection basin parameter prediction sub-model using the second deflection basin parameter value, the pavement structural incompleteness rate value and the pavement overall roughness index value to obtain the second deflection basin parameter prediction sub-model.

In the embodiments of the present invention, by reducing the dimensions of multiple deflection basin evaluation indexes, two index values with a higher degree of tightness to the second initial deflection basin parameter prediction sub-model, namely the pavement overall roughness index value and the overall pavement roughness index value, are obtained. And by determining the second deflection basin parameter prediction sub-model based on these two index values, the training speed of the second deflection basin parameter prediction sub-model can be increased, and the prediction efficiency of the predicted value of the second deflection basin parameter can be improved, thereby further improving the prediction efficiency of the deflection basin parameters.

At the same time, in the embodiments of the present invention, in addition to obtaining the first deflection basin parameter prediction sub-model for predicting the first deflection basin parameters, the second deflection basin parameter prediction sub-model is also obtained to predict the deflection basin parameters at the second sampling point. By jointly describing the deflection of the road section through the predicted value of the first deflection basin parameter and the predicted value of the second deflection basin parameter, compared with only using the predicted value of the first deflection basin parameter, the description of the deflection basin is more accurate.

Among them, the pavement structural incompleteness rate value is:

$$SIR = \frac{{S}_{α}}{A}$$

Wherein, SIR is the pavement structural incompleteness rate value, S_{α} is the area of the abnormal region in the radar image, specifically the sum of the looseness area and the crack area.

Among them, the pavement overall roughness index value is:

$$RORI = IRI + 0.5 RD$$

Wherein, RORI is the pavement overall roughness index value, IRI is the international roughness index value, RD is the rut depth value.

To further accurately describe the parameters at other positions of the deflection basin besides the reference point and the first sampling point, that is, to improve the accuracy of the deflection basin description, in some embodiments of the present invention, at least one deflection basin parameter value further includes the third deflection basin parameter value of the third sampling point. That is, the deflection basin formed by the road surface under load is described by the deflection basin parameter values of the three sampling points, thereby improving the accuracy of the deflection basin description.

Herein, the distance between the third sampling point and the reference point is greater than the distance between the second sampling point and the reference point.

In a specific embodiment of the present invention, the deflection basin parameter prediction model includes a third deflection basin parameter prediction sub-model;
then, before S102, the method further comprises:
training a third initial deflection basin parameter prediction sub-model using the third deflection basin parameter value, the crack cross-sectional area index value, the settlement rate value, the looseness rate value, and the void rate value to obtain the third deflection basin parameter prediction sub-model.

Among them, the third deflection basin prediction sub-model focuses on the structural performance of the base layer and the upper part of the subbase layer. Since the rut depth value, international roughness index value, and damage rate value are indicators used to characterize the surface layer, setting the input parameters of the third deflection basin parameter prediction sub-model to exclude the rut depth value, international roughness index value, and damage rate value can reduce the dimensionality of the input parameters of the third deflection basin parameter prediction sub-model. This can further improve the training efficiency of the third deflection basin parameter prediction sub-model, thereby enhancing the prediction efficiency of the deflection basin parameters.

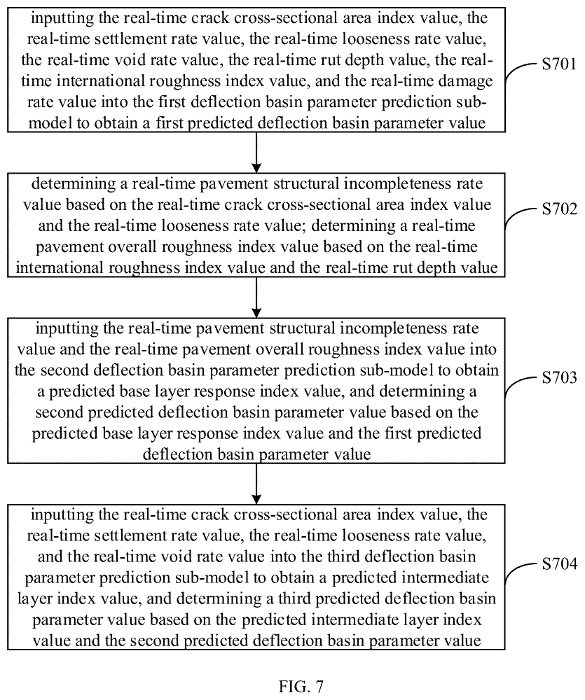

In the embodiments of the present invention, the real-time values of deflection basin evaluation indexes include a real-time crack cross-sectional area index value, a real-time settlement rate value, a real-time looseness rate value, a real-time void rate value, a real-time rut depth value, a real-time international roughness index value, and a real-time damage rate value;
wherein, as shown in FIG. 7, S102, comprises:
S701, inputting the real-time crack cross-sectional area index value, the real-time settlement rate value, the real-time looseness rate value, the real-time void rate value, the real-time rut depth value, the real-time international roughness index value, and the real-time damage rate value into the first deflection basin parameter prediction sub-model to obtain a first predicted deflection basin parameter value;
S702, determining a real-time pavement structural incompleteness rate value based on the real-time crack cross-sectional area index value and the real-time looseness rate value;
determining a real-time pavement overall roughness index value based on the real-time international roughness index value and the real-time rut depth value;
S703, inputting the real-time pavement structural incompleteness rate value and the real-time pavement overall roughness index value into the second deflection basin parameter prediction sub-model to obtain a predicted base layer response index value, and determining a second predicted deflection basin parameter value based on the predicted base layer response index value and the first predicted deflection basin parameter value;
S704, inputting the real-time crack cross-sectional area index value, the real-time settlement rate value, the real-time looseness rate value, and the real-time void rate value into the third deflection basin parameter prediction sub-model to obtain a predicted intermediate layer index value, and determining a third predicted deflection basin parameter value based on the predicted intermediate layer index value and the second predicted deflection basin parameter value.

Among them, the second predicted deflection basin parameter value is the difference between the predicted base layer response index value and the first predicted deflection basin parameter value, and the third predicted deflection basin parameter value is the difference between the predicted intermediate layer index value and the second predicted deflection basin parameter value. That is:

$$\begin{matrix}BLI = {D}_{1} - {D}_{2} \\ MLI = {D}_{3} - {D}_{2}\end{matrix}$$

Wherein, BLI is the predicted base layer response index value, D₁ is the first predicted deflection basin parameter value, D₂ is the second predicted deflection basin parameter value, MLI is the predicted intermediate layer index value, D₃ is the third predicted deflection basin parameter value.

In the embodiments, the overall structural performance including the surface layer, base layer, subbase layer, and soil subgrade can be evaluated by setting up the first deflection basin parameter prediction sub-model. The structural performance of the surface layer can be evaluated by setting up the second deflection basin parameter prediction sub-model. The structural performance of the base layer and the layers below can be evaluated by setting up the third deflection basin parameter prediction sub-model. That is to say, through the above three deflection basin parameter prediction sub-models, the overall and local evaluation of the road section can be realized, which improves the accuracy and rationality of the road section evaluation, and further enhances the rationality of the road maintenance plan formulated based on the predicted parameter values of the above three deflection basins.

As the number of sampling points increases, that is, the more deflection basin parameters are used to describe the deflection basin, the more accurate the description of the deflection basin becomes. Therefore, in some embodiments, at least one deflection basin parameter value further includes the fourth deflection basin parameter value of the fourth sampling point, the fifth deflection basin parameter value of the fifth sampling point, the sixth deflection basin parameter value of the sixth sampling point, and the seventh deflection basin parameter value of the seventh sampling point.

Herein, the distance between the fourth sampling point and the reference point is greater than the distance between the third sampling point and the reference point; the distance between the fifth sampling point and the reference point is greater than the distance between the fourth sampling point and the reference point; the distance between the sixth sampling point and the reference point is greater than the distance between the fifth sampling point and the reference point; the distance between the seventh sampling point and the reference point is greater than the distance between the sixth sampling point and the reference point.

In the embodiments of the present invention, the deflection basin is described jointly by the seven deflection basin parameter values corresponding to the seven sampling points arranged from the closest to the farthest from the reference point, which can improve the accuracy of the deflection basin description, that is, enhance the adaptability between the determined deflection basin parameters and the deflection basin.

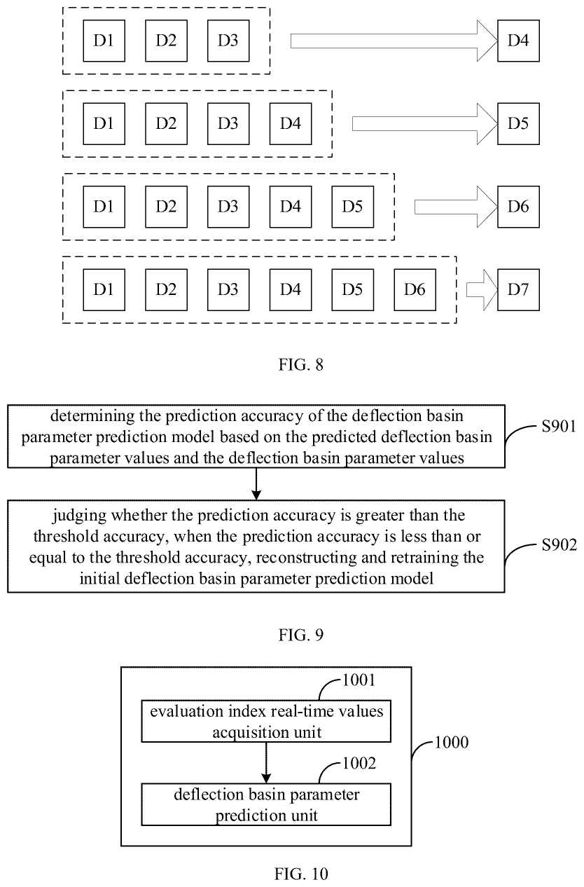

It should be noted that since the fourth deflection basin parameter prediction value, the fifth deflection basin parameter prediction sub-model, the sixth deflection basin parameter prediction value, and the seventh deflection basin parameter prediction sub-model do not differ significantly and their data sequence trends are obvious, to improve the training speed of these models, in some embodiments of the present invention, a sequence prediction method is used to train the fourth, fifth, sixth, and seventh deflection basin parameter prediction sub-models sequentially. Specifically, as shown in FIG. 8, S102 further includes:
training the constructed fourth initial deflection basin parameter prediction sub-model based on the first deflection basin parameter prediction value, the second deflection basin parameter prediction value, and the third deflection basin parameter prediction value to obtain the fourth deflection basin parameter prediction sub-model.

That is, the inputs of the fourth deflection basin parameter prediction sub-model are the first deflection basin parameter prediction value, the second deflection basin parameter prediction value, and the third deflection basin parameter prediction value.

Similarly, as shown in FIG. 8, S102 further includes:
obtaining the fourth deflection basin parameter prediction value D4 based on the fourth deflection basin parameter prediction sub-model;
training the constructed fifth initial deflection basin parameter prediction sub-model based on the first deflection basin parameter prediction value D1, the second deflection basin parameter prediction value D2, the third deflection basin parameter prediction value D3, and the fourth deflection basin parameter prediction value D4 to obtain the fifth deflection basin parameter prediction sub-model.

By analogy, as shown in FIG. 8, the constructed sixth initial deflection basin parameter prediction sub-model is trained based on the first deflection basin parameter prediction value D1, the second deflection basin parameter prediction value D2, the third deflection basin parameter prediction value D3, the fourth deflection basin parameter prediction value D4, and the fifth deflection basin parameter prediction value D5 to obtain the sixth deflection basin parameter prediction sub-model.

The constructed seventh initial deflection basin parameter prediction sub-model is trained based on the first deflection basin parameter prediction value D1, the second deflection basin parameter prediction value D2, the third deflection basin parameter prediction value D3, the fourth deflection basin parameter prediction value D4, the fifth deflection basin parameter prediction value D5, and the sixth deflection basin parameter prediction value D6 to obtain the seventh deflection basin parameter prediction sub-model.

After establishing the above seven deflection basin parameter prediction sub-models, S102 specifically is:
based on the first deflection basin parameter prediction sub-model, the second deflection basin parameter prediction sub-model, the third deflection basin parameter prediction sub-model, the fourth deflection basin parameter prediction sub-model, the fifth deflection basin parameter prediction sub-model, the sixth deflection basin parameter prediction sub-model, and the seventh deflection basin parameter prediction sub-model, obtain the first deflection basin parameter prediction value D1, the second deflection basin parameter prediction value D2, the third deflection basin parameter prediction value D3, the fourth deflection basin parameter prediction value D4, the fifth deflection basin parameter prediction value D5, the sixth deflection basin parameter prediction value D6, and the seventh deflection basin parameter prediction value D7, so as to determine the deflection basin parameters.

In order to further ensure the accuracy of the determined deflection basin parameter prediction values, in some embodiments of the present invention, as shown in FIG. 9, after S102, it further comprises:
S901, determining the prediction accuracy of the deflection basin parameter prediction model based on the predicted deflection basin parameter values and the deflection basin parameter values;
S902, judging whether the prediction accuracy is greater than the threshold accuracy, when the prediction accuracy is less than or equal to the threshold accuracy, reconstructing and retraining the initial deflection basin parameter prediction model.

It should be understood that when the prediction accuracy is greater than the threshold accuracy, the deflection basin parameter prediction model meets the requirements and can be used directly.

In the embodiments of the present invention, by verifying the accuracy of the predicted deflection basin parameter values, the accuracy of the determined predicted deflection basin parameter values can be ensured.

In a specific embodiment of the present invention, the first predicted deflection basin parameter values and the first deflection basin parameter values are shown in Table 1:

TABLE 1
the first predicted deflection basin parameter values

| | | | | | | | | | |
|---|---|---|---|---|---|---|---|---|---|
| the first predicted | 10.44 | 14.45 | 15.31 | 9.85 | 10.69 | 8.27 | 8.66 | 12.59 | 8.67 |
| deflection basin parameter | | | | | | | | | |
| value | | | | | | | | | |
| the first deflection basin | 9.91 | 14.32 | 15.60 | 11.02 | 10.21 | 9.53 | 8.20 | 12.66 | 7.55 |
| parameter value | | | | | | | | | |
| the first predicted | 8.44 | 9.10 | 10.45 | 9.52 | 12.42 | 11.12 | 8.79 | 8.88 | 12.48 |
| deflection basin parameter | | | | | | | | | |
| value | | | | | | | | | |
| the first deflection basin | 8.48 | 9.33 | 10.63 | 9.41 | 11.76 | 10.76 | 7.56 | 6.96 | 13.40 |
| parameter value | | | | | | | | | |

Based on the data in Table 1, calculate the coefficient of determination (R²) of the predicted values of the first deflection basin parameters. Use the coefficient of determination to evaluate the prediction accuracy of the first deflection basin parameter prediction sub-model. The threshold accuracy is 0.7. The coefficient of determination of the above Table 1 is 0.84, which is higher than 0.7. It can be seen that the prediction accuracy of the first deflection basin parameter prediction sub-model in the embodiments of the present invention is relatively high.

The coefficient of determination of the predicted values of the second deflection basin parameters is 0.79, the coefficient of determination of the predicted values of the third deflection basin parameters is 0.866, the coefficient of determination of the predicted values of the fourth deflection basin parameters is 0.945, the coefficient of determination of the predicted values of the fifth deflection basin parameters is 0.933, the coefficient of determination of the predicted values of the sixth deflection basin parameters is 0.903, and the coefficient of determination of the predicted values of the seventh deflection basin parameters is 0.927, all of which are higher than 0.7. That is, the prediction accuracy of all the deflection basin parameter prediction sub-models is relatively high.

It should be noted that in some embodiments of the present invention, the accuracy of each deflection basin parameter prediction sub-model can also be verified simultaneously by the coefficient of determination, the mean squared error (MSE) and the mean absolute error (MAE), which will not be elaborated in detail here.

In some embodiments of the present invention, the first deflection basin parameter prediction sub-model, the third deflection basin parameter prediction sub-model, the fourth deflection basin parameter prediction sub-model, the fifth deflection basin parameter prediction sub-model, the sixth deflection basin parameter prediction sub-model, and the seventh deflection basin parameter prediction sub-model are support vector regression machines (SVR). The second deflection basin parameter prediction sub-model is a multiple linear regression model.

In the specific embodiment of the present invention, the second deflection basin parameter prediction sub-model is:

$$BLI = 0.47 + 0.16 RORI + 0.88 SIR .$$

In the embodiments of the present invention, the support vector regression machine is applicable to the prediction scenarios with a small sample size. It has strong nonlinear capabilities, can handle complex nonlinear regression problems, has strong robustness to outliers, is not easily interfered by outliers, has strong model generalization ability, and has good prediction ability. It can handle high-dimensional data, avoiding the problem of the curse of dimensionality, and improving the robustness and generalization ability of each deflection basin parameter prediction sub-model.

At the same time, in the embodiments of the present invention, by setting the second deflection basin parameter prediction sub-model as a multiple linear regression model, it has strong interpretability and is simple to calculate.

In order to verify the availability of the multiple linear regression model, in the embodiments of the present invention, by setting the second deflection basin parameter prediction sub-model as a support vector regression (SVR), a random forest regression (RFR) and an XG Boost model, the prediction performance of these models is compared with that of the multiple linear regression model. The comparison results are shown in Table 2.

TABLE 2
Comparison of the results of the second predicted
deflection basin parameter values

| Performance | | | |
|---|---|---|---|
| metric | SVR | RFR | XG boost |
| R² | 0.803 | 0.26 | 0.15 |
| MSE | 0.15 | 0.562 | 0.875 |

As can be seen from Table 2, the prediction performance of SVR is significantly better than the other two models. The coefficient of determination of the multiple linear regression model is 0.79, which is not significantly different from that of SVR. Compared with SVR, the multiple linear regression model is computationally simpler and more applicable.

Similarly, the performance of the first, third, fourth, fifth, sixth, and seventh deflection basin parameter prediction sub-models can also be verified separately. Taking the verification process of the third deflection basin parameter prediction sub-model as an example, the model structure of the third deflection basin prediction sub-model is set to SVR, BP-NN, XG Boost, and KNN respectively. The comparison results of their prediction accuracies are shown in Table 3:

TABLE 3
Comparison of the results of the third predicted
deflection basin parameter values

| Performance | | | | |
|---|---|---|---|---|
| metric | SVR | BP-NN | XG boost | KNN |
| R² | 0.866 | 0.6 | 0.77 | 0.642 |
| MSE | 0.081 | 0.244 | 0.141 | 0.219 |
| MAE | 0.25 | 0.438 | 0.3 | 0.375 |

It can be seen from Table 3 that the R2 values of the four prediction methods are 0.866, 0.6, 0.77, and 0.642 respectively. Among them, the prediction accuracy of SVR reaches 0.866, which is relatively high, verifying its superiority.

It should be noted that the model parameters of the support vector regression machine mainly include two parameters: the kernel function and the penalty coefficient. In the specific embodiments of the present invention, the kernel function of the first deflection basin parameter prediction sub-model is a linear kernel function, and the penalty coefficient is 10. The kernel function of the third deflection basin parameter prediction sub-model is a linear kernel function, and the penalty coefficient is 11. The kernel function of the fourth deflection basin parameter prediction sub-model is a linear kernel function, and the penalty coefficient is 9.5. The kernel function of the fifth deflection basin parameter prediction sub-model is a linear kernel function, and the penalty coefficient is 10.5. The kernel function of the sixth deflection basin parameter prediction sub-model is a linear kernel function, and the penalty coefficient is 11. The kernel function of the seventh deflection basin parameter prediction sub-model is a linear kernel function, and the penalty coefficient is 11.

In certain specific application scenarios, only one predicted value of the deflection basin parameter is needed to represent the deflection condition of the road section to be tested. At this time, the seven predicted values of the deflection basin parameters determined in the above embodiments are averaged, and this average value is used as the representative value of the deflection basin of this road section to be tested.

In summary, the embodiments of the present invention have established seven deflection basin parameter prediction sub-models. Among them, the first three parameters need to be predicted based on the pavement performance or hidden diseases as the data basis, and the latter four are directly predicted by means of sequence prediction. The prediction accuracy R² of all prediction models has reached 0.8. This indicates that in the actual pavement detection process, the detector only needs to perform the performance detection and GPR detection to judge the approximate condition of the pavement deflection basin parameters, which enhances the robustness of the detection data and improves the detection efficiency. At the same time, the obtained deflection basin data can be further used to obtain more specific resilient modulus information through modulus back calculation.

Corresponding to the method for determining deflection basin parameters, the present invention also provides an apparatus for determining deflection basin parameters. As shown in FIG. 10, the apparatus for determining deflection basin parameters 1000 comprises:
evaluation index real-time values acquisition unit 1001, configured to obtain real-time values of deflection basin evaluation indexes at any point in a test road section using ground-penetrating radar;
deflection basin parameter prediction unit 1002, configured to input the real-time values of the deflection basin evaluation indexes into a deflection basin parameter prediction model to obtain predicted deflection basin parameter values;
wherein, the deflection basin parameter prediction model is trained based on at least one deflection basin parameter value and deflection basin evaluation index values corresponding to reference points in a reference road section; the at least one deflection basin parameter value is determined by falling weight deflectometer, and the deflection basin evaluation index values are determined by the ground-penetrating radar.

The apparatus for determining deflection basin parameters 1000 provided by the above mentioned embodiments can implement the technical solutions described in the embodiments of the method for determining deflection basin parameters. The specific embodiment principles of the above mentioned modules or units can be referred to the corresponding content in the embodiments of the method for determining deflection basin parameters, and will not be repeated here.

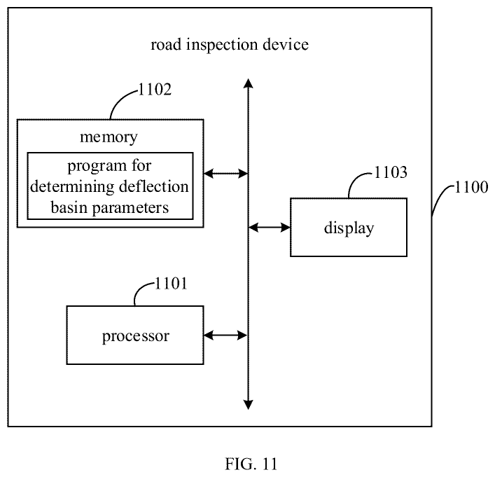

As shown in FIG. 11, the present invention also provides a road inspection device 1100. The road inspection device 1100 includes a processor 1101, a memory 1102, and a display 1103. FIG. 11 only shows some components of the road inspection device 1100. It should be understood that it is not required to implement all the shown components, and more or fewer components can be implemented alternatively.

The processor 1101 can be a Central Processing Unit (CPU), a micro processor, or other data processing chips in some embodiments. It is used to run the program code stored in the memory 1102 or process data, such as the foot reflex zones identification method of the present invention.

In some embodiments of the present invention, the processor 1101 may be a single server or a server group. The server group may be centralized or distributed. In some embodiments, the processor 1101 may be local or remote. In some embodiments, the processor 1101 may be implemented on a cloud platform. In one embodiment, the cloud platform may include a private cloud, a public cloud, a hybrid cloud, a community cloud, a distributed cloud, an internal cloud, a multi-cloud, etc., or any combination thereof.

The memory 1102 can be an internal storage unit of the road inspection device 1100 in some embodiments, such as a hard disk or memory of the road inspection device 1100. In other embodiments, the memory 1102 can also be an external storage device of the road inspection device 1100, such as a plug-in hard disk, a Smart Media Card (SMC), a Secure Digital (SD) card, a Flash Card, etc. equipped on the road inspection device 1100.

Further, the memory 1102 can include both the internal storage unit and the external storage device of the road inspection device 1100. The memory 1102 is used to store the application software installed on the road inspection device 1100 and various types of data.

In some embodiments, the display 1103 can be an LED display, a liquid crystal display, a touch type liquid crystal display, an OLED (Organic Light-Emitting Diode) touch device, etc. The display 1103 is used to display the information of the road inspection device 1100 and a visual user interface. The components 1101-1103 of the road inspection device 1100 communicate with each other through the system bus.

In some embodiments of the present invention, when the processor 1101 executes program for determining deflection basin parameters in the memory 1102, the following steps can be implemented:
obtaining real-time values of deflection basin evaluation indexes at any point in a test road section using ground-penetrating radar;
inputting the real-time values of the deflection basin evaluation indexes into a deflection basin parameter prediction model to obtain predicted deflection basin parameter values;
wherein, the deflection basin parameters prediction model is trained based on at least one deflection basin parameter value and deflection basin evaluation index values corresponding to reference points in a reference road section; the at least one deflection basin parameter value is determined by falling weight deflectometer, and the deflection basin evaluation index values are determined by the ground-penetrating radar.

It should be understood that when the processor 1101 executes the program determining deflection basin parameters in the memory 1102, in addition to the above mentioned functions, it can also implement other functions. For specific details, please refer to the descriptions of the relevant method embodiments above.

Furthermore, the embodiments of the present invention do not specifically limit the type of the road inspection device 1100 mentioned. The road inspection device 1100 can be portable road inspection devices such as mobile phones, tablet computers, personal digital assistants (PDAs), wearable devices, laptop computers, etc. Exemplary embodiments of portable road inspection devices include, but are not limited to, portable road inspection devices equipped with operating systems such as iOS, Android, Microsoft, or others. The above-mentioned portable road inspection devices can also be other portable road inspection devices. It should also be understood that in some other embodiments of the present invention, the road inspection device 1100 may not be a portable road inspection device, but a desktop computer with a sensitive touch surface (such as a touch panel).

Correspondingly, the embodiments of the present invention also provide a computer-readable storage medium. The computer-readable storage medium is used to store programs or instructions that can be read by a computer. When the programs or instructions are executed by a processor, they can implement the steps or functions of the method for determining deflection basin parameters provided by the above mentioned method embodiments.

Correspondingly, the embodiments of the present invention also provide a computer program product, which includes a computer program/instructions. When the computer program/instructions are executed by a processor, the steps of the method for determining deflection basin parameters in any of the above mentioned embodiments are implemented.

It is understood by those skilled in the art that all or part of the process to implement the above embodiments may be accomplished by instructs the relevant hardware (e.g. processor, controller, etc.) through a computer program that may be stored in a computer readable storage medium. Among them, the computer readable storage medium is disk, optical disc, read-only storage memory or random storage memory.

The above method and apparatus for determining deflection basin parameters, road inspection device, medium and product provided by the invention are introduced in detail. The principle and embodiment mode of the invention are described in this paper with specific examples. The above embodiment is only used to help understand the method and its core idea of the invention. At the same time, for the technical personnel in the field, according to the idea of the invention, there will be changes in the specific mode of embodiment and scope of application, in summary, the content of this specification should not be understood as a limitation of the invention.

What is claimed is:

1. A method for determining deflection basin parameters, comprises:
obtaining real-time values of deflection basin evaluation indexes at any point in a test road section using ground-penetrating radar;
inputting the real-time values of the deflection basin evaluation indexes into a deflection basin parameter prediction model to obtain predicted deflection basin parameter values;
wherein, the deflection basin parameters prediction model is trained based on at least one deflection basin parameter value and deflection basin evaluation index values corresponding to reference points in a reference road section; the at least one deflection basin parameter value is determined by falling weight deflectometer, and the deflection basin evaluation index values are determined by the ground-penetrating radar;
the at least one deflection basin parameter value includes a first deflection basin parameter value at a first sampling point, a second deflection basin parameter value at a second sampling point, and a third deflection basin parameter value at a third sampling point, wherein a distance between the second sampling point and the reference point is greater than a distance between the first sampling point and the reference point, and a distance between the third sampling point and the reference point is greater than the distance between the second sampling point and the reference point; the deflection basin parameter prediction model includes a first deflection basin parameter prediction sub-model, a second deflection basin parameter prediction sub-model, and a third deflection basin parameter prediction sub-model;
the deflection basin evaluation index values include a crack cross-sectional area index value, a settlement rate value, a looseness rate value, a void rate value, a rut depth value, an international roughness index value, and a damage rate value;
before inputting the real-time values of the deflection basin evaluation indexes into the deflection basin parameter prediction model to obtain the predicted deflection basin parameter values, the method further comprises:
training a first initial deflection basin parameter prediction sub-model using the first deflection basin parameter value, the crack cross-sectional area index value, the settlement rate value, the looseness rate value, the void rate value, the rut depth value, the international roughness index value, and the damage rate value to obtain the first deflection basin parameter prediction sub-model;
training a second initial deflection basin parameter prediction sub-model using the second deflection basin parameter value, the crack cross-sectional area index value, the looseness rate value, the international roughness index value, and the rut depth value to obtain the second deflection basin parameter prediction sub-model;
training a third initial deflection basin parameter prediction sub-model using the third deflection basin parameter value, the crack cross-sectional area index value, the settlement rate value, the looseness rate value, and the void rate value to obtain the third deflection basin parameter prediction sub-model;
the real-time values of deflection basin evaluation indexes include a real-time crack cross-sectional area index value, a real-time settlement rate value, a real-time looseness rate value, a real-time void rate value, a real-time rut depth value, a real-time international roughness index value, and a real-time damage rate value; wherein inputting the real-time values of the deflection basin evaluation indexes into the deflection basin parameter prediction model to obtain the predicted deflection basin parameter values comprises:
inputting the real-time crack cross-sectional area index value, the real-time settlement rate value, the real-time looseness rate value, the real-time void rate value, the real-time rut depth value, the real-time international roughness index value, and the real-time damage rate value into the first deflection basin parameter prediction sub-model to obtain a first predicted deflection basin parameter value;
inputting the real-time crack cross-sectional area index value, the real-time looseness rate value, the real-time international roughness index value, and the real-time rut depth value into the second deflection basin parameter prediction sub-model to obtain a predicted base layer response index value, and determining a second predicted deflection basin parameter value based on the predicted base layer response index value and the first predicted deflection basin parameter value;
inputting the real-time crack cross-sectional area index value, the real-time settlement rate value, the real-time looseness rate value, and the real-time void rate value into the third deflection basin parameter prediction sub-model to obtain a predicted intermediate layer index value, and determining a third predicted deflection basin parameter value based on the predicted intermediate layer index value and the second predicted deflection basin parameter value.

2. The method for determining deflection basin parameters of claim 1, before obtaining real-time values of deflection basin evaluation indexes at any point in a test road section using ground-penetrating radar, comprises:
establishing the deflection basin evaluation indexes;
wherein, the deflection basin evaluation indexes include the crack cross-sectional area index, the settlement rate, the looseness rate, and the void rate.

3. The method for determining deflection basin parameters of claim 2, before inputting the real-time values of the deflection basin evaluation indexes into a deflection basin parameter prediction model to obtain predicted deflection basin parameter values, comprises:
acquiring the at least one deflection basin parameter value and the deflection basin evaluation index values of the reference point, and training the deflection basin parameter prediction model based on the at least one deflection basin parameter value and the deflection basin evaluation index values.

4. The method for determining deflection basin parameters of claim 3, acquiring the deflection basin evaluation index values of the reference point, comprises:
obtaining a reflected voltage and a radar image of the reference point using the ground-penetrating radar;
determining the crack cross-sectional area index value based on the reflected voltage;
determining the settlement rate value, the looseness rate value, and the void rate value based on the radar image.

5. The method for determining deflection basin parameters of claim 4, determining the crack cross-sectional area index value based on the reflected voltage, comprises:
determining a number of voltage peaks and peak voltage values of the reflected voltage, and determining a number of hidden cracks at the reference point based on the number of voltage peaks;
determining hidden crack depth and hidden crack width of each hidden crack based on the peak voltage values, a first correspondence between peak voltage and hidden crack depth, and a second correspondence between peak voltage and hidden crack width;
determining the crack cross-sectional area index value based on the hidden crack depth and the hidden crack width.

6. The method for determining deflection basin parameters of claim 4, determining the settlement rate value, the looseness rate value, and the void rate value based on the radar image, comprises:
identifying at least one settlement region, at least one looseness region, and at least one void region in the radar image;
determining a settlement location and settlement area for each settlement region, and determining the settlement rate value based on the settlement location and settlement area;
determining a looseness location and looseness area for each looseness region, and determining the looseness rate value based on the looseness location and looseness area;
determining a void location and void area for each void region, and determining the void rate value based on the void location and void area.

7. The method for determining deflection basin parameters of claim 6, determining the settlement rate value based on the settlement location and settlement area, comprises:
determining a settlement location weight for each settlement region based on the settlement location;
determining the settlement rate value based on the settlement location weight and the settlement area.

8. The method for determining deflection basin parameters of claim 7, determining a settlement location weight for each settlement region based on the settlement location, comprises:
establishing a first mapping relationship between a settlement center and the settlement location weight;
determining a settlement center of the settlement location, and determining the settlement location weight based on the settlement center and the first mapping relationship.

9. The method for determining deflection basin parameters of claim 3, the method for determining deflection basin parameters further comprises:
determining a rut depth value, an international roughness index value, and a damage rate value of the reference point using a multifunctional road condition rapid detection system.

10. The method for determining deflection basin parameters of claim 1, training a second initial deflection basin parameter prediction sub-model using the second deflection basin parameter value, the crack cross-sectional area index value, the looseness rate value, the international roughness index value, and the rut depth value to obtain the second deflection basin parameter prediction sub-model, comprises:
determining a pavement structural incompleteness rate value based on the crack cross-sectional area index value and the looseness rate value;
determining a pavement overall roughness index value based on the international roughness index value and the rut depth value;
training the second initial deflection basin parameter prediction sub-model using the second deflection basin parameter value, the pavement structural incompleteness rate value and the pavement overall roughness index value to obtain the second deflection basin parameter prediction sub-model.

11. The method for determining deflection basin parameters of claim 1, the at least one deflection basin parameter value further includes a fourth deflection basin parameter value at a fourth sampling point, wherein a distance between the fourth sampling point and the reference point is greater than the distance between the third sampling point and the reference point; the deflection basin parameter prediction model further includes a fourth deflection basin parameter prediction sub-model;
before inputting the real-time values of the deflection basin evaluation indexes into the deflection basin parameter prediction model to obtain the predicted deflection basin parameter values, the method further comprises:
training a fourth initial deflection basin parameter prediction sub-model using the first predicted deflection basin parameter value, the second predicted deflection basin parameter value, and the third predicted deflection basin parameter value to obtain the fourth deflection basin parameter prediction sub-model.

12. The method for determining deflection basin parameters of claim 11, the at least one deflection basin parameter value further includes a fifth deflection basin parameter value at a fifth sampling point, wherein a distance between the fifth sampling point and the reference point is greater than the distance between the fourth sampling point and the reference point;
before inputting the real-time values of the deflection basin evaluation indexes into the deflection basin parameter prediction model to obtain the predicted deflection basin parameter values, the method further comprises:
obtaining a fourth predicted deflection basin parameter value using the fourth deflection basin parameter prediction sub-model;
training a fifth initial deflection basin parameter prediction sub-model using the first predicted deflection basin parameter value, the second predicted deflection basin parameter value, the third predicted deflection basin parameter value, and the fourth predicted deflection basin parameter value to obtain a fifth deflection basin parameter prediction sub-model.

13. An apparatus for determining deflection basin parameters, applicable to the method according to claim 1, comprises:
evaluation index real-time values acquisition unit, configured to obtain real-time values of deflection basin evaluation indexes at any point in a test road section using ground-penetrating radar;
deflection basin parameter prediction unit, configured to input the real-time values of the deflection basin evaluation indexes into a deflection basin parameter prediction model to obtain predicted deflection basin parameter values;
wherein, the deflection basin parameter prediction model is trained based on at least one deflection basin parameter value and deflection basin evaluation index values corresponding to reference points in a reference road section; the at least one deflection basin parameter value is determined by falling weight deflectometer, and the deflection basin evaluation index values are determined by the ground-penetrating radar.

14. A road inspection device, comprising memory and processor, among which, the memory is used to store a program;
the processor coupled with the memory, is used to execute the program stored in the memory to implement the steps in the method for determining deflection basin parameters according to claim 1.

15. A computer-readable storage medium, the computer-readable storage medium stores a program or instructions that, when executed by a processor, implement the steps of the deflection basin parameter determination method according to claim 1.

16. A computer program product, comprising a computer program/instructions, the computer program/instructions, when executed by a processor, implement the steps of the deflection basin parameter determination method according to claim 1.
